(19) United States
(12) Patent Application Publication
(10) Pub. No.: US 2021/0294851 A1
(43) Pub. Date: Sep. 23, 2021

(54) System and method for data augmentation for document understanding

(71) Applicant: UiPath, Inc., New York, NY (US)

(72) Inventor: Rukma Talwadker, Bangalore (IN)

(73) Assignee: UiPath, Inc., New York, NY (US)

(21) Appl. No.: 16/827,189

(22) Filed: Mar. 23, 2020

(51) Int. Cl. G06F 16/906; G06K 9/00

(52) U.S. Cl. CPC G06F 16/906; G06K 9/00442

(57) ABSTRACT

A system, method and a computing device for performing a method for data augmentation allowing for document classification of a plurality of documents are disclosed. The system, method and computing device including a processor configured to convert the plurality of documents into images, a memory configured to store the images, the processor configured to obtain a vector representation for each page included in the plurality of documents, the processor configured to create a plurality of clusters from the images based on similarity, where each cluster of the plurality of clusters represents a distinct page format, the processor configured to select one image from each cluster of the plurality of clusters, the processor configured to compile the selected one image from each cluster of the plurality of clusters to create a logically complete document, the memory configured to store the logically complete document, and the processor configured to train the classification based on the complete document.

### FIELD OF INVENTION

The present invention is related to the field of document understanding, and more particularly, to a data augmentation technique for creating training sets for machine learning model to classify documents for further processing.

### BACKGROUND

Data augmentation techniques enable practitioners to significantly increase the diversity of data available for training models. In many cases, data augmentation involves synthesizing newer samples from the existing samples. In the case of images, there are well known ways of creating sample images by position, such as scaling, cropping and rotation, for example, and color, such as brightness, contrast and hue, for example. For unstructured text, for example for documents and emails there exist data augmentation techniques such as replacing words with their synonyms, rephrasing the sentence using word embedding, including, e.g., Word2vec, Glove and Fasttext. These data augmentation examples may be used when the sample set is large. However, no proven data augmentation solution exists in the area of semi-structured (e.g. variable structured forms) and fixed structure (e.g. fixed structure forms) documents.

Within the semi structured and the fixed structured documents, large enough samples are available but not directly consumable by the machine learning classifier. This happens when multiple document samples are scanned as one single report back to back. In these situations, the document start and end pages are not demarcated. Most often, the report may contain several hundreds, or even more samples, of the document for given category. Generally, a manually understanding of the document is required split and to re-synthesize the training set causing traditional data augmentation methods to generally be inapplicable. Existing solutions include limiting view to the first few pages of the document. The first few pages can be very generic templates and not contain the relevant document sample. Therefore, such existing solutions provide bad or limited accuracy. Other solutions manually split each document into multiple pages adding time and making the process time consuming and unscalable.

### SUMMARY

A system and method for data augmentation allowing for document classification of a plurality of documents are disclosed. The system and method includes converting the plurality of documents into images, obtaining a vector representation for each page included in the plurality of documents, creating a plurality of clusters from the images based on similarity, where each cluster of the plurality of clusters represents a distinct page format, selecting one image from each cluster of the plurality of clusters, compiling the selected one image from each cluster of the plurality of clusters to create a logically complete document, and training the classification based on the complete document.

A computing device for performing a method for data augmentation allowing for document classification of a plurality of documents is also disclosed. The device including a processor configured to convert the plurality of documents into images, a memory configured to store the images, the processor configured to obtain a vector representation for each page included in the plurality of documents, the processor configured to create a plurality of clusters from the images based on similarity, where each cluster of the plurality of clusters represents a distinct page format, the processor configured to select one image from each cluster of the plurality of clusters, the processor configured to compile the selected one image from each cluster of the plurality of clusters to create a logically complete document, the memory configured to store the logically complete document, and the processor configured to train the classification based on the complete document.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is an illustration of robotic process automation (RPA) development, design, operation, or execution;

FIG. 1B is another illustration of RPA development, design, operation, or execution;

FIG. 1C is an illustration of a computing system or environment;

FIG. 2 illustrates a method of data augmentation allowing training ML models for document classification of a plurality of documents; and

FIG. 3 illustrates a method for identifying the logical start and end of individual reports in a large document.

### DETAILED DESCRIPTION

For the methods and processes described herein, the steps recited may be performed out of sequence in any order and sub-steps not explicitly described or shown may be performed. In addition, “coupled” or “operatively coupled” may mean that objects are linked but may have zero or more intermediate objects between the linked objects. Also, any combination of the disclosed features/elements may be used in one or more embodiments. When using referring to “A or B”, it may include A, B, or A and B, which may be extended similarly to longer lists. When using the notation X/Y it may include X or Y. Alternatively, when using the notation X/Y it may include X and Y. X/Y notation may be extended similarly to longer lists with the same explained logic.

A large training data set may be augmented using a machine learning (ML) model. This data augmentation provides results that are more trustworthy when nearly equal numbers of sample documents are provided for the various classes of documents for which the model is to be trained. In many cases of data augmentation, a sample document may include multiple pages. In addition multiple samples of the same type of document may be concatenated into one large document. When this occurs, the document may span multiple hundreds or thousands of pages. In order to train a classifier to understand this class of documents, generally one has to manually split this large document into individual documents. This is a tedious task assuming that the same process has to be repeated across each class of documents to be trained.

The present system and method for data augmentation operate for document classification where a larger number of training data samples are created for training models from a smaller set of documents that contain multiple pages. Initially, the documents, which contain multiple pages, for training the model are converted into images and a vector representation for each page is obtained. Then clusters of similar kinds of images are formed, where each cluster represents a distinct page format. One image from each cluster may be randomly chosen to create a logically complete document. This process may be repeated in order to train the ML model for classification of documents. Moreover, the system is also capable of identifying the logical start and end of documents in a set of documents provided. This is a completely unsupervised mechanism of data sampling and data augmentation.

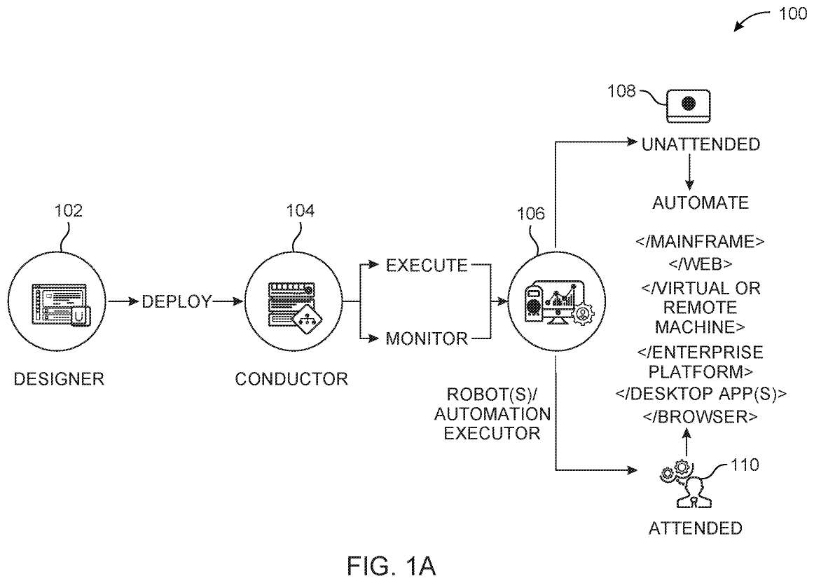

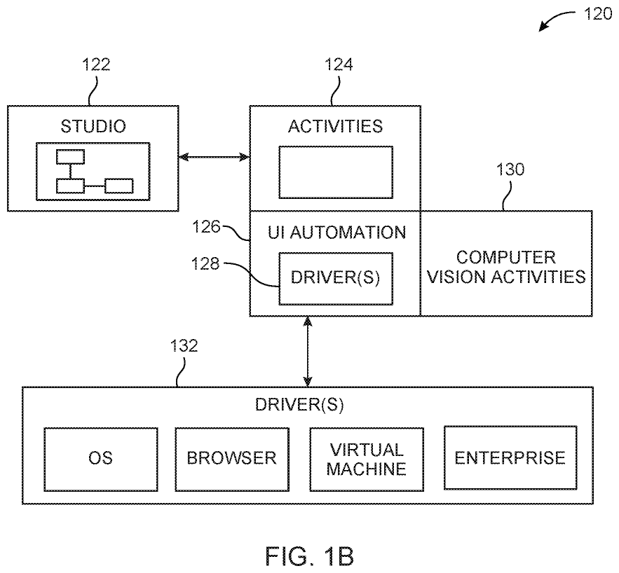

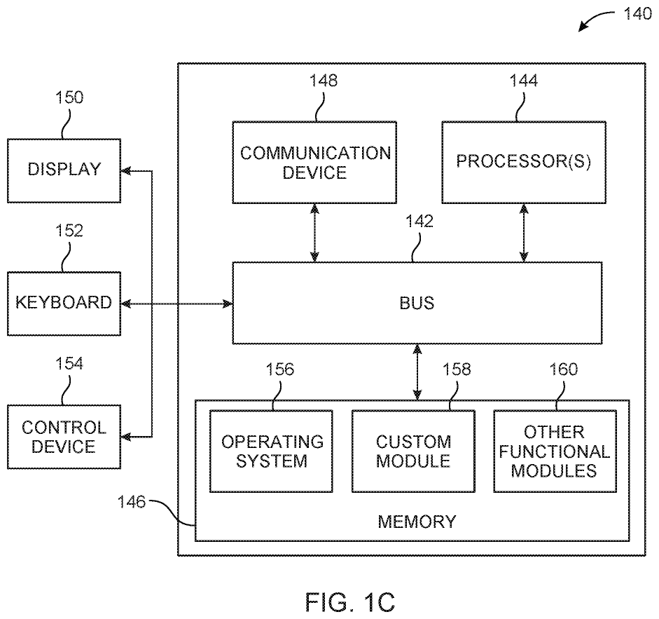

FIG. 1A is an illustration of robotic process automation (RPA) development, design, operation, or execution 100. Designer 102, sometimes referenced as a studio, development platform, development environment, or the like may be configured to generate code, instructions, commands, or the like for a robot to perform or automate one or more workflows. From a selection(s), which the computing system may provide to the robot, the robot may determine representative data of the area(s) of the visual display selected by a user or operator. As part of RPA, shapes such as squares, rectangles, circles, polygons, freeform, or the like in multiple dimensions may be utilized for UI robot development and runtime in relation to a computer vision (CV) operation or machine learning (ML) model.

Non-limiting examples of operations that may be accomplished by a workflow may be one or more of performing login, filling a form, information technology (IT) management, or the like. To run a workflow for UI automation, a robot may need to uniquely identify specific screen elements, such as buttons, checkboxes, text fields, labels, etc., regardless of application access or application development. Examples of application access may be local, virtual, remote, cloud, Citrix®, VMWare®, VNC®, Windows® remote desktop, virtual desktop infrastructure (VDI), or the like. Examples of application development may be win32, Java, Flash, hypertext markup language ((HTML), HTML5, extensible markup language (XML), JavaScript, C#, C++, Silverlight, or the like.

A workflow may include, but are not limited to, task sequences, flowcharts, Finite State Machines (FSMs), global exception handlers, or the like. Task sequences may be linear processes for handling linear tasks between one or more applications or windows. Flowcharts may be configured to handle complex business logic, enabling integration of decisions and connection of activities in a more diverse manner through multiple branching logic operators. FSMs may be configured for large workflows. FSMs may use a finite number of states in their execution, which may be triggered by a condition, transition, activity, or the like. Global exception handlers may be configured to determine workflow behavior when encountering an execution error, for debugging processes, or the like.

A robot may be an application, applet, script, or the like, that may automate a UI transparent to an underlying operating system (OS) or hardware. At deployment, one or more robots may be managed, controlled, or the like by a conductor 104, sometimes referred to as an orchestrator. Conductor 104 may instruct or command robot(s) or automation executor 106 to execute or monitor a workflow in a mainframe, web, virtual machine, remote machine, virtual desktop, enterprise platform, desktop app(s), browser, or the like client, application, or program. Conductor 104 may act as a central or semi-central point to instruct or command a plurality of robots to automate a computing platform.

In certain configurations, conductor 104 may be configured for provisioning, deployment, configuration, queueing, monitoring, logging, and/or providing interconnectivity. Provisioning may include creating and maintenance of connections or communication between robot(s) or automation executor 106 and conductor 104. Deployment may include assuring the delivery of package versions to assigned robots for execution. Configuration may include maintenance and delivery of robot environments and process configurations. Queueing may include providing management of queues and queue items. Monitoring may include keeping track of robot identification data and maintaining user permissions. Logging may include storing and indexing logs to a database (e.g., an SQL database) and/or another storage mechanism (e.g., ElasticSearch®, which provides the ability to store and quickly query large datasets). Conductor 104 may provide interconnectivity by acting as the centralized point of communication for third-party solutions and/or applications.

Robot(s) or automation executor 106 may be configured as unattended 108 or attended 110. For unattended 108 operations, automation may be performed without third party inputs or control. For attended 110 operation, automation may be performed by receiving input, commands, instructions, guidance, or the like from a third party component. Unattended 108 or attended 110 robots may run or execute on mobile computing or mobile device environments.

A robot(s) or automation executor 106 may be execution agents that run workflows built in designer 102. A commercial example of a robot(s) for UI or software automation is UiPath Robots™. In some embodiments, robot(s) or automation executor 106 may install the Microsoft Windows® Service Control Manager (SCM)-managed service by default. As a result, such robots can open interactive Windows® sessions under the local system account, and have the rights of a Windows® service.

In some embodiments, robot(s) or automation executor 106 may be installed in a user mode. These robots may have the same rights as the user under which a given robot is installed. This feature may also be available for High Density (HD) robots, which ensure full utilization of each machine at maximum performance such as in an HD environment.

In certain configurations, robot(s) or automation executor 106 may be split, distributed, or the like into several components, each being dedicated to a particular automation task or activity. Robot components may include SCM-managed robot services, user mode robot services, executors, agents, command line, or the like. SCM-managed robot services may manage or monitor Windows® sessions and act as a proxy between conductor 104 and the execution hosts (i.e., the computing systems on which robot(s) or automation executor 106 is executed). These services may be trusted with and manage the credentials for robot(s) or automation executor 106.

User mode robot services may manage and monitor Windows® sessions and act as a proxy between conductor 104 and the execution hosts. User mode robot services may be trusted with and manage the credentials for robots. A Windows® application may automatically be launched if the SCM-managed robot service is not installed.

Executors may run given jobs under a Windows® session (i.e., they may execute workflows). Executors may be aware of per-monitor dots per inch (DPI) settings. Agents may be Windows® Presentation Foundation (WPF) applications that display available jobs in the system tray window. Agents may be a client of the service. Agents may request to start or stop jobs and change settings. The command line may be a client of the service. The command line is a console application that can request to start jobs and waits for their output.

In configurations where components of robot(s) or automation executor 106 are split as explained above helps developers, support users, and computing systems more easily run, identify, and track execution by each component. Special behaviors may be configured per component this way, such as setting up different firewall rules for the executor and the service. An executor may be aware of DPI settings per monitor in some embodiments. As a result, workflows may be executed at any DPI, regardless of the configuration of the computing system on which they were created. Projects from designer 102 may also be independent of browser zoom level. For applications that are DPI-unaware or intentionally marked as unaware, DPI may be disabled in some embodiments.

FIG. 1B is another illustration of RPA development, design, operation, or execution 120. A studio component or module 122 may be configured to generate code, instructions, commands, or the like for a robot to perform one or more activities 124. User interface (UI) automation 126 may be performed by a robot on a client using one or more driver(s) components 128. A robot may perform activities using computer vision (CV) activities module or engine 130. Other drivers 132 may be utilized for UI automation by a robot to get elements of a UI. They may include OS drivers, browser drivers, virtual machine drivers, enterprise drivers, or the like. In certain configurations, CV activities module or engine 130 may be a driver used for UI automation.

FIG. 1C is an illustration of a computing system or environment 140 that may include a bus 142 or other communication mechanism for communicating information or data, and one or more processor(s) 144 coupled to bus 142 for processing. One or more processor(s) 144 may be any type of general or specific purpose processor, including a central processing unit (CPU), application specific integrated circuit (ASIC), field programmable gate array (FPGA), graphics processing unit (GPU), controller, multi-core processing unit, three dimensional processor, quantum computing device, or any combination thereof. One or more processor(s) 144 may also have multiple processing cores, and at least some of the cores may be configured to perform specific functions. Multi-parallel processing may also be configured. In addition, at least one or more processor(s) 144 may be a neuromorphic circuit that includes processing elements that mimic biological neurons.

Memory 146 may be configured to store information, instructions, commands, or data to be executed or processed by processor(s) 144. Memory 146 can be comprised of any combination of random access memory (RAM), read only memory (ROM), flash memory, solid-state memory, cache, static storage such as a magnetic or optical disk, or any other types of non-transitory computer-readable media or combinations thereof. Non-transitory computer-readable media may be any media that can be accessed by processor(s) 144 and may include volatile media, non-volatile media, or the like. The media may also be removable, non-removable, or the like.

Communication device 148, may be configured as a frequency division multiple access (FDMA), single carrier FDMA (SC-FDMA), time division multiple access (TDMA), code division multiple access (CDMA), orthogonal frequency-division multiplexing (OFDM), orthogonal frequency-division multiple access (OFDMA), Global System for Mobile (GSM) communications, general packet radio service (GPRS), universal mobile telecommunications system (UMTS), cdma2000, wideband CDMA (W-CDMA), high-speed downlink packet access (HSDPA), high-speed uplink packet access (HSUPA), high-speed packet access (HSPA), long term evolution (LTE), LTE Advanced (LTE-A), 802.11x, Wi-Fi, Zigbee, Ultra-WideBand (UWB), 802.16x, 802.15, home Node-B (HnB), Bluetooth, radio frequency identification (RFID), infrared data association (IrDA), near-field communications (NFC), fifth generation (5G), new radio (NR), or any other wireless or wired device/transceiver for communication via one or more antennas. Antennas may be singular, arrayed, phased, switched, beamforming, beamsteering, or the like.

One or more processor(s) 144 may be further coupled via bus 142 to a display device 150, such as a plasma, liquid crystal display (LCD), light emitting diode (LED), field emission display (FED), organic light emitting diode (OLED), flexible OLED, flexible substrate displays, a projection display, 4K display, high definition (HD) display, a Retina© display, in-plane switching (IPS) or the like based display. Display device 150 may be configured as a touch, three dimensional (3D) touch, multi-input touch, or multi-touch display using resistive, capacitive, surface-acoustic wave (SAW) capacitive, infrared, optical imaging, dispersive signal technology, acoustic pulse recognition, frustrated total internal reflection, or the like as understood by one of ordinary skill in the art for input/output (I/O).

A keyboard 152 and a control device 154, such as a computer mouse, touchpad, or the like, may be further coupled to bus 142 for input to computing system or environment 140. In addition, input may be provided to computing system or environment 140 remotely via another computing system in communication therewith, or computing system or environment 140 may operate autonomously.

Memory 146 may store software components, modules, engines, or the like that provide functionality when executed or processed by one or more processor(s) 144. This may include an OS 156 for computing system or environment 140. Modules may further include a custom module 158 to perform application specific processes or derivatives thereof. Computing system or environment 140 may include one or more additional functional modules 160 that include additional functionality.

Computing system or environment 140 may be adapted or configured to perform as a server, an embedded computing system, a personal computer, a console, a personal digital assistant (PDA), a cell phone, a tablet computing device, a quantum computing device, cloud computing device, a mobile device, a smartphone, a fixed mobile device, a smart display, a wearable computer, or the like.

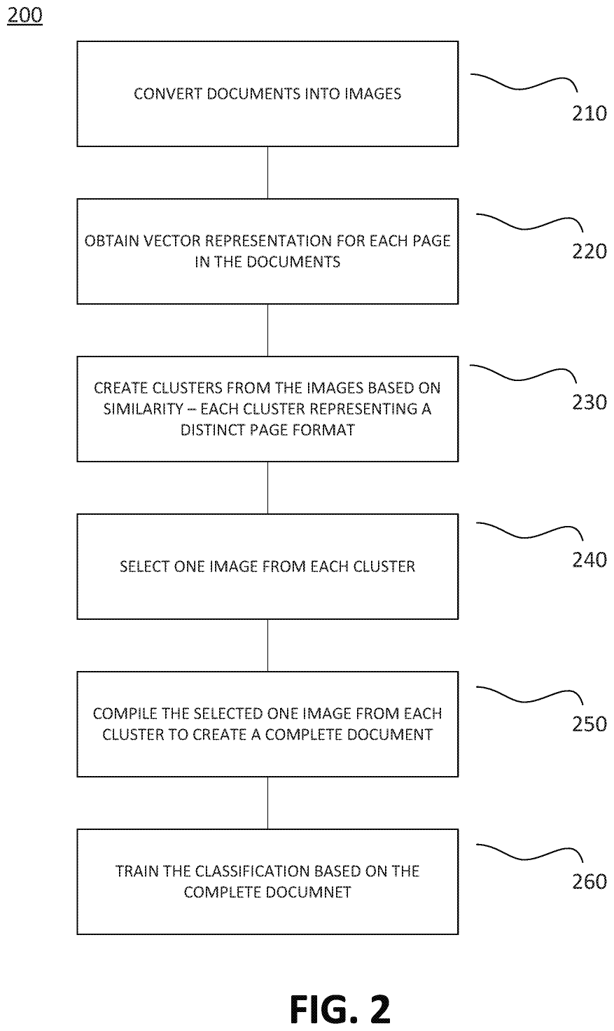

FIG. 2 illustrates a method 200 of data augmentation allowing training ML models for document classification of a plurality of documents. Method 200 includes converting documents into images at step 210. At step 220, method 200 includes obtaining a vector representation for each image. At step 230, clusters are created from the vectors to identify distinct page formats. At step 240, one image from each cluster may be selected to ensure that each format is used for training the model. At step 250, multiple ones of the selected one image may be compiled to create a complete document. At step 260, the classification may be trained based on the complete document.

In an exemplary implementation for identifying distinct type of pages within a document, step 210 of method 200 may include converting the documents provided for classification as images and obtaining a vector representation for each page at step 220. This image and vector representation may be obtained using pre-trained image models such as VGG or RESNET.

These image vectors are used to cluster the images of similar type at step 230. These clusters may be formed with 6 dimensions by reducing dimensionality through a ML technique called Principle Component Analysis (PCA) or a normal VGG based cluster that provides large numbers of dimensions of a page. Using PCA encodes the multi-dimensional information into fewer succinct dimensions and hence the first few significant dimensions are good enough. As would be understood, the number of significant dimensions may vary, such as from 4-10 dimensions for example. More specifically, dimensions from 5-7 may be used. Even more specifically, 6 dimensions may be used.

After PCA, the total numbers of clusters (k) that best fit the image features are obtained. The value of k is obtained by performing the clustering of images and the value of k is varied from 2 to 10. The k value may be determined with minimum error and highest accuracy of clustering using the ELBOW method and SILHOUETTE index. In step 230, both of these methods may be leveraged to arrive at a value of k. This creates the clusters with each cluster representing a distinct page format. For example, if three clusters are being generated such as “Start page”, “Data page” and “Image page,” the images that are classified as “Start page” are stored in a “Start page” cluster, and similarly, for “Data page” in a “Data page” cluster and for “Image page” in an “Image page” cluster. While three types of cluster are used in the example, one of skill in the art would understand that this is exemplary only, as any number of clusters may be formed.

After clusters are formed at step 230, a random page from each cluster is picked at step 240 and these picked random pages are compiled into a single synthetic document at step 250 and used to train the ML model at step 260. In order to create a balanced training set, multiple document instances can be synthesized from a single large page document. This process can be selectively repeated across all the input documents and across the various document classes. This trained ML model is used in the RPA workflow described above as an ML activity for classifying the documents.

An exemplary use case for identifying distinct types of pages within a document according to method 200 is described below. Treat or convert each page of the document to an image. Use pre-trained image models like VGG, RESNET, etc., to obtain image vectors for each image. Once the vectors are obtained and images converted, the image vectors may be clustered allowing segregation of similar page images together. Image vectors may be large (and even multi-dimensional). For example, in situations of the VGG based embedding, the image vector may be 224×224×3, which is 150,528 features/dimensions per page. Instead of clustering on such a high number of dimensions, a reduction to a smaller number of significant dimensions may be performed. For example, a dimensionality reduction via PCA may be used to quantify the most significant 6 dimensions.

After PCA, the total number of clusters (k) to best fit the image features may be determined using one or more of several metrics. Using one metric by computing a clustering accuracy on varying k values, from 2 to 10. The ELBOW method may be used to find the k with minimum error or highest accuracy of clustering. The SILHOUETTE index may be used to find the best k. Using one or more of the methods to find k, the results may be programmatically combined to arrive at the value of k and perform clustering.

At this point, each cluster represents a distinct page format (image) in a multi report document. The data can be augmented by sampling random pages from each of the clusters to create a synthetic document for training. In so doing, multiple synthetic reports are generated that represent a class from a single multi-report document. The total number of pages sampled from a given cluster for constructing a single report can be proportionate to the total number of page samples in a cluster.

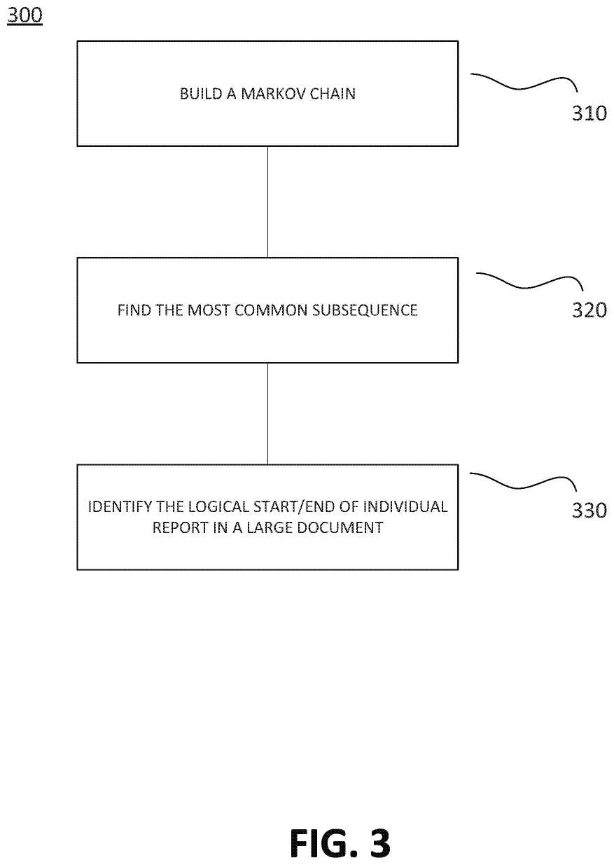

Further, the present system and method enables the logical start and end of the document in the set of documents to be determined. FIG. 3 illustrates a method 300 for identifying the logical start and end of individual reports in a large document. Method 300 includes building a Markov chain at step 310. Method 300 includes finding the most common subsequence at step 320. At step 330, method 300 includes identifying the logical start/end of an individual report in a large document.

Building the Markov chain, also referred to as a state transition map, at step 310 may occur after completing method 200 to identify distinct pages. In the building step 310, the system indexes each page with its corresponding cluster id. Based on the actual order of the pages, a Markov chain is built at step 310, where cluster ids denote the state and transition from one page to another and further denotes the edge between the states. The start state represents the previous page and end state represents the current page. Edge weights may be used to indicate the total number of times pages in cluster x were followed by the pages in cluster y.

Finding the most common subsequence at step 320 may include traversing the directed Markov chain built in step 310 to enumerate all the possible state sequences. Each subsequence ends when an already encountered state is revisited. The weight of the entire sequence is the least edge weight seen during the entire sequence traversal. After completing traversal, all the sub-sequences with their corresponding weights are assessed. The subsequence with highest weight is chosen. If there are multiple sub-sequences with similar high score, the first subsequence with highest length is chosen.

Identifying the logical start/end of an individual report in a large document at step 330 includes identifying the cluster id corresponding to the start of the subsequence that was found in step 320 to mark the report start and report end. Every page in between is thus determined to be a part of the report. Pages are laid out in the order of their appearance in the report with their corresponding cluster ids. When a start cluster id is encountered, until the end cluster id, or a yet again a start cluster id is found, the report is grouped to indicate an individual report. This process of document segmentation continues until the end of the document.

The approaches disclosed herein may be utilized where there is data augmentation by sampling, for example. Performance of a classifier may be increased by 10, 20, 50% from the baseline imbalanced model. Data accuracy with the present data augmentation and training of the model may be approximately 99% across all document classes. The present approaches in training the ML system with more data improve the accuracy and efficiency of the system. The present approaches eliminate the need for manual document annotation. The present system can classify the documents more accurately and can easily find the start and end of a report.

Additionally, when this ML service is deployed for the classification, the test documents may include multiple instances of the same document class presented for classification as a single large document. Classifier should be able to pick the right sample of page for the classification, as set forth above, knowing that the first few pages of the sample may be irrelevant and may not accurately represent the document class.

In the examples given herein, modules may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may be at least partially implemented in software for execution by various types of processors. An identified unit of executable code may include one or more physical or logical blocks of computer instructions that may, for instance, be organized as an object, procedure, routine, subroutine, or function. Executables of an identified module co-located or stored in different locations such that, when joined logically together, comprise the module.

A module of executable code may be a single instruction, one or more data structures, one or more data sets, a plurality of instructions, or the like distributed over several different code segments, among different programs, across several memory devices, or the like. Operational or functional data may be identified and illustrated herein within modules, and may be embodied in a suitable form and organized within any suitable type of data structure.

In the examples given herein, a computer program may be configured in hardware, software, or a hybrid implementation. The computer program may be composed of modules that are in operative communication with one another, and to pass information or instructions.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for data augmentation allowing for document classification of a plurality of documents, the method comprising:
converting the plurality of documents into images;
obtaining a vector representation for each page included in the plurality of documents;
creating a plurality of clusters from the images based on similarity, where each cluster of the plurality of clusters represents a distinct page format;
selecting one image from each cluster of the plurality of clusters;
compiling the selected one image from each cluster of the plurality of clusters to create a logically complete document; and
training the classification based on the complete document.

2. The method of claim 1 wherein the selecting of one image from each cluster ensures that each format is used for training the model.

3. The method of claim 1 wherein creating a plurality of clusters occurs from the vectors to identify distinct page formats.

4. The method of claim 1 wherein the image and vector representation is obtained using pre-trained image models.

5. The method of claim wherein the trained models includes at least one of VGG and RESNET.

6. The method of claim 1 wherein the cluster are formed by reducing dimensionality through a ML technique called Principle Component Analysis (PCA) or a normal VGG based cluster that provides large numbers of dimensions of a page.

7. The method of claim 6 wherein the dimensions are 6.

8. The method of claim 6 wherein using PCA encodes the multi-dimensional information into fewer succinct dimensions.

9. The method of claim 6 wherein the dimensions are 4-10 dimensions

10. The method of claim 1 wherein t total number of clusters (k) that best fit the image features are obtained.

11. The method of claim 10 wherein the value of k is obtained by performing the clustering of images and the value of k is varied from 2 to 10.

12. The method of claim 10 wherein the k value may be determined with minimum error and highest accuracy of clustering using the ELBOW method and SILHOUETTE index.

13. A computing device for performing a method for data augmentation allowing for document classification of a plurality of documents, the device comprising:
a processor configured to convert the plurality of documents into images;
a memory configured to store the images;
the processor configured to obtain a vector representation for each page included in the plurality of documents;
the processor configured to create a plurality of clusters from the images based on similarity, where each cluster of the plurality of clusters represents a distinct page format;
the processor configured to select one image from each cluster of the plurality of clusters;
the processor configured to compile the selected one image from each cluster of the plurality of clusters to create a logically complete document;
the memory configured to store the logically complete document; and
the processor configured to train the classification based on the complete document.

14. The device of claim 13 wherein the selecting of one image from each cluster ensures that each format is used for training the model.

15. The device of claim 13 wherein creating a plurality of clusters occurs from the vectors to identify distinct page formats.

16. The device of claim 13 wherein the image and vector representation is obtained using pre-trained image models.

17. The device of claim 13 wherein the trained models includes at least one of VGG and RESNET.

18. The device of claim 13 wherein the cluster are formed by reducing dimensionality through a ML technique called Principle Component Analysis (PCA) or a normal VGG based cluster that provides large numbers of dimensions of a page.

19. The device of claim 13 wherein using PCA encodes the multi-dimensional information into fewer succinct dimensions.

20. The device of claim 13 wherein the k value may be determined with minimum error and highest accuracy of clustering using the ELBOW method and SILHOUETTE index.
